(19) United States
(12) Patent Application Publication
(10) Pub. No.: US 2026/0362580 A1
(43) Pub. Date: Nov. 12, 2026

(54) DEVICE FOR GENERATING AND ACCELERATING ION WIND, AND HIGH-VISIBILITY SIGNAGE DEVICE AND LIGHTING DEVICE INCLUDING SAME

(71) Applicant: SP&E CO. LTD., Hwaseong-si, Gyeonggi-do (KR)

(72) Inventor: Sung Woo KIM, Osan-si, Gyeonggi-do (KR)

(21) Appl. No.: 19/153,596

(22) PCT Filed: Feb. 7, 2023
(86) PCT No.: PCT/KR2023/001725

§ 371 Date: Aug. 4, 2025

(30) Foreign Application Priority Data
Feb. 2, 2023 (KR) 10-2023-0014156

(51) Int. Cl. H05H 11/00; G09F 13/04; H01T 23/00

(52) U.S. Cl. CPC H05H 11/00; G09F 13/04; H01T 23/00

(57) ABSTRACT

The present invention relates to a device for generating and accelerating ion wind, and a high-visibility signage device and a lighting device including same. The device for generating and accelerating ion wind comprises: a power source; a high-voltage generator that receives power from the power source and outputs high-voltage power for plasma discharge; a discharge electrode plate providing a supporting force; an ion wind generation unit that is mounted to the discharge electrode plate and connected to the high-voltage generator, and includes a plurality of electrode members for generating ion wind by ionizing the surrounding air through plasma discharge; and an ion wind induction means for accelerating and inducing the ion wind generated from the ion wind generation unit.

### TECHNICAL FIELD

The present disclosure relates to an apparatus for generating and accelerating an ionic wind and a high-visibility signage device and a lighting device using the same, and more particularly, to an apparatus for generating and accelerating an ionic wind, which improves the visibility of a target to be viewed by generating and accelerating an ionic wind and diffusing and venting the ionic wind to the front of the target to be viewed so that the ions of an ionic wind settle floating foreign substance in front of the target to be viewed, and a high-visibility signage device and a lighting device having the same

### BACKGROUND ART

An ionic wind by plasma discharge is generated as ions generated from a discharge electrode are moved from the discharge electrode to a ground electrode by the action of Coulomb force. That is, the moving ions collide against air molecules and push and move the air molecules in the same direction. Such a movement of the air molecules is the ionic wind. In order to generate a stronger ionic wind, it is essential to generate more ions and to accelerate the generated ions at a high speed.

FIG. 1 is a diagram for describing the principle in which an ionic wind is generated.

As illustrated in FIG. 1, when a high voltage HV is applied to a needle electrode, that is, a discharge electrode, plasma by a strong electric field is generated around the needle electrode. Ions that are generated by the plasma discharge move to a cylinder electrode that is a ground electrode, collide against surrounding air molecules, and are divided into ions and free electrons by discharging outer electrons of the air molecules. The free electrons generated at this time generate an electron avalanche phenomenon in which a large amount of electrons and ions are generated within a plasma discharge area by successively repeating the same process.

The ions that are generated through the process move toward the cylinder electrode while pushing the surrounding air molecules that are electrically neutral. The air that is pushed by the ions is applied with kinetic energy of the ions, and some of the air is moved by friction with the ions and passes through the cylinder electrode. The air molecules that pass through the cylinder electrode correspond to an ionic wind.

Furthermore, hydroxide (OH) radical ions are widely used in an air purifier because the OH radical ions sterilize microorganisms or viruses that are floating in the air, reduce fine dust, and have an air purification effect of removing smell.

Moreover, the ionic wind also has the properties of neutralizing and setting smoke and toxic gases generated in the event of fire, ultra fine dust, soot, exhaust soot, and noxious gases and a granular material generated upon combustion. If the ionic wind is used, the line of sight of a person requiring evacuation can be secured in the event of a fire, thereby enabling rapid and safe evacuation guidance.

As a technology, that is, the background of the present disclosure related thereto, there was disclosed Korean Patent Application Publication No. 10-2023-0006751 (entitled “LIFTING TYPE IONIC WIND AIR CLEANER”).

The disclosed air cleaner is a lifting type ionic wind air cleaner, including an emitter that generates charges by corona discharge, a plurality of collectors disposed over the emitter, disposed to be spaced apart from each other, and configured to generate an ionic wind when applied with a power supply, a plurality of non-collection units disposed alternately with the collectors and configured to enable particles charged in the collectors to be dust-collected, and a case on which the emitter, the collectors, and the non-collection unit are mounted and which is disposed at a mounting point, that is, the ceiling of an indoor space or an upper part of a wall, wherein the case is moved up and down from a point at a predetermined height of the ground to a mounting point.

As well known, in the event of a fire in a building, a power outage may occur, plunging the interior space into darkness. Even the signage devices indicating the direction of emergency exits may become obscured by smoke and toxic gases. However, even in such an urgent situation, the presence of a highly visible signage device indicating emergency exit can help reduce potential casualties to some extent.

However, a conventional display device (including various types of guide lights) is not well viewed because thick and dark smoke and toxic gases block light although the conventional display device has high illuminance. Only one life can be saved only when the visibility of a signage device (including various types of guide lights) is rapidly secured by removing noxious gases and granular materials that cover the signage device and that are generated from combustion. There is a need for a technology that removes floating combustion byproducts (e.g., soot, exhaust soot, and ultrafine dust) and secures a visible distance.

### DISCLOSURE

### Technical Problem

The present disclosure has an object of providing an apparatus for generating and accelerating an ionic wind, which makes a target to be viewed checked more sharply by removing suspended matters in the air in front of the target to be viewed by using an ionic wind, and a high-visibility signage device and a lighting device having the same.

Furthermore, the present disclosure has an object of providing an apparatus for generating and accelerating an ionic wind, which has high reliability because the apparatus can operate normally even in the event of a power outage caused by a fire, and a high-visibility signage device and a lighting device having the same.

### Technical Solution

An apparatus for generating and accelerating an ionic wind according to the present disclosure as solving means for accomplishing the objects includes a power supply, a high voltage generator configured to output high voltage power for plasma discharge by receiving power of the power supply, an ionic wind generator including a discharge electrode plate configured to provide a support force and multiple electrode members mounted on the discharge electrode plate, connected to the high voltage generator, and configured to generate an ionic wind by ionizing surrounding air through plasma discharge, and ionic wind induction means for accelerating and inducing the ionic wind generated by the ionic wind generator.

Furthermore, the ionic wind induction means includes a magnet configured to apply a magnetic force to the ionic wind generated by the ionic wind generator so that the ionic wind is accelerated by the action of the magnetic force.

Furthermore, the ionic wind induction means further includes an acceleration plate configured to provide a Venturi hole that transmits the ionic wind accelerated by the magnet and that additionally accelerates the ionic wind.

Furthermore, the electrode member is an acicular electrode having a shape in which a front part thereof is pointed. The acceleration plate is disposed to be spaced apart from the discharge electrode plate with the electrode member interposed therebetween. The Venturi hole is a through hole through which a central axis line of the electrode member passes, and includes an inflow unit configured to receive the ionic wind, an acceleration unit configured to accelerate the ionic wind that passes through the inflow unit, and an outflow unit configured to diffuse the ionic wind passing through the acceleration unit.

Furthermore, the magnet includes a first magnet having a ring shape and fixed to the discharge electrode plate in the state in which the first magnet surrounds the electrode member and a second magnet having a ring shape, mounted on the acceleration plate, and configured to form a magnetic force line tunnel that provides guidance to a flow of the ionic wind along with the first magnet.

Furthermore, the power supply includes a commercial power supply, an emergency power supply that operates when the commercial power supply is blocked, or a hydroelectric generator mounted on a pipe through which fire fighting water passes and configured to produce power by receiving kinetic energy of the fire fighting water.

Furthermore, a high-visibility signage device of the present disclosure includes a power supply, a signage unit including a board plate connected to the power supply and configured to provide a support force and multiple optical output units mounted on the board plate and configured to operate by power applied from the outside, an ionic wind generator including a high voltage generator configured to output high voltage power for plasma discharge, a discharge electrode plate configured to provide a support force, and multiple electrode members mounted on the discharge electrode plate, connected to the high voltage generator, and configured to generate an ionic wind by ionizing surrounding air through plasma discharge, and ionic wind induction means for improving the visibility of the signage unit by inducing the ionic wind generated by the ionic wind generator so that the ionic wind is spread to a front of the signage unit.

Furthermore, another high-visibility signage device according to an embodiment of the present disclosure includes a power supply, a signage unit including an optical output unit connected to the power supply and a display unit installed in front of the optical output unit, configured to indicate signage contents, and viewed by taking the optical output unit as a backlight, an ionic wind generator including a high voltage generator configured to output high voltage power for plasma discharge, a discharge electrode plate configured to provide a support force, and multiple electrode members mounted on the discharge electrode plate, connected to the high voltage generator, and configured to generate an ionic wind by ionizing surrounding air through plasma discharge, and ionic wind induction means for improving the visibility of the display unit by inducing the ionic wind generated by the ionic wind generator so that the ionic wind is spread to a front of the display unit.

Furthermore, the ionic wind induction means includes a magnet configured to accelerate the ionic wind by the action of a magnetic force by applying the magnetic force to the ionic wind generated by the ionic wind generator.

Furthermore, the ionic wind induction means further includes an acceleration plate configured to provide a Venturi hole that transmits the ionic wind accelerated by the magnet and that additionally accelerates the ionic wind.

Furthermore, the magnet includes a first magnet having a ring shape and fixed to the discharge electrode plate in the state in which the first magnet surrounds the electrode member and a second magnet having a ring shape, mounted on the acceleration plate, and configured to form a magnetic force line tunnel that provides guidance to a flow of the ionic wind along with the first magnet.

Furthermore, a high-visibility lighting device of the present disclosure includes a power supply, a lighting lamp connected to the power supply, an ionic wind generator including a high voltage generator configured to output a high voltage for plasma discharge, a discharge electrode plate configured to provide a support force, and multiple electrode members mounted on the discharge electrode plate, connected to the high voltage generator, and configured to generate an ionic wind by ionizing surrounding air through plasma discharge, and ionic wind induction means for improving the visibility of the lighting lamp by inducing the ionic wind generated by the ionic wind generator so that the ionic wind is spread to a front of the lighting lamp.

Furthermore, the ionic wind induction means includes a magnet configured to accelerate the ionic wind by the action of a magnetic force by applying the magnetic force to the ionic wind generated by the ionic wind generator.

Furthermore, the ionic wind induction means further includes an acceleration plate configured to provide a Venturi hole that transmits the ionic wind accelerated by the magnet and that additionally accelerates the ionic wind.

Furthermore, the magnet includes a first magnet having a ring shape and fixed to the discharge electrode plate in the state in which the first magnet surrounds the electrode member and a second magnet having a ring shape, mounted on the acceleration plate, and configured to form a magnetic force line tunnel that provides guidance to a flow of the ionic wind along with the first magnet.

### Advantageous Effects

As described above, the apparatus for generating and accelerating an ionic wind according to an embodiment of the present disclosure improves the visibility of a target to be viewed, including various guidance lights in evacuation, aisles, auditoriums, and voice blinking lights, and a lighting device, by diffusing and venting a high-speed ionic wind to the front of the target to be viewed so that suspended matters that hinder a visual field are rapidly removed by using the high-speed ionic wind.

Furthermore, the effective range of an ionic wind can be expanded by further diffusing and venting the ionic wind by using the magnetic tunnel having a high magnetic force and the Venturi hole.

Furthermore, when a commercial power supply is turned on under normal operating conditions and the commercial power supply is cut off because power is blocked in the event of a power outage due to a fire, the device switches to the emergency power supply, thereby enabling a normal operation and ensuring high reliability.

The signage device can be disposed in emergency escapes, such as various buildings, underground parking lots and facilities, various tunnels, large ships, subways, factories, large warehouse stores, and multi-use facilities, or points including emergency exit doors, door frames, stairs, corridors, ceilings, side walls, and floors, and may be fabricated and applied in any shape.

### BRIEF DESCRIPTION OF DRAWINGS

FIG. 1 is a diagram for describing the principle in which an ionic wind is generated.

FIG. 2A is a block diagram illustrating an operating method of a high-visibility signage device including an apparatus for generating and accelerating an ionic wind according to an embodiment of the present disclosure.

FIG. 2B is a block diagram illustrating an operating method of a high-visibility lighting device including the apparatus for generating and accelerating an ionic wind according to an embodiment of the present disclosure.

FIG. 3 is a perspective view of a signage device using the apparatus for generating and accelerating an ionic wind according to an embodiment of the present disclosure.

FIG. 4 is an exploded perspective view of the signage device of FIG. 3.

FIG. 5 is a cross-sectional view taken along line A-A in FIG. 4.

FIG. 6 is a diagram for describing an operating principle of the apparatus for generating and accelerating an ionic wind according to an embodiment of the present disclosure.

FIG. 7 is a diagram for describing an ionic wind acceleration principle in the apparatus for generating and accelerating an ionic wind, which is illustrated in FIG. 6.

FIG. 8 is a partially cut perspective view of the high-visibility signage device including the apparatus for generating and accelerating an ionic wind according to an embodiment of the present disclosure.

FIG. 9 is a perspective view illustrating another example of the high-visibility signage device including the apparatus for generating and accelerating an ionic wind according to an embodiment of the present disclosure.

FIG. 10 is a side view of the high-visibility signage device illustrated in FIG. 9.

FIG. 11 is a diagram illustrating still another example of the high-visibility signage device including the apparatus for generating and accelerating an ionic wind according to an embodiment of the present disclosure.

FIG. 12 is a plan view of the high-visibility signage device illustrated in FIG. 11.

FIG. 13 is an exploded perspective view illustrating a high-visibility lighting device including the apparatus for generating and accelerating an ionic wind according to an embodiment of the present disclosure.

FIG. 14 is a diagram for describing internal components of the high-visibility lighting device of FIG. 13.

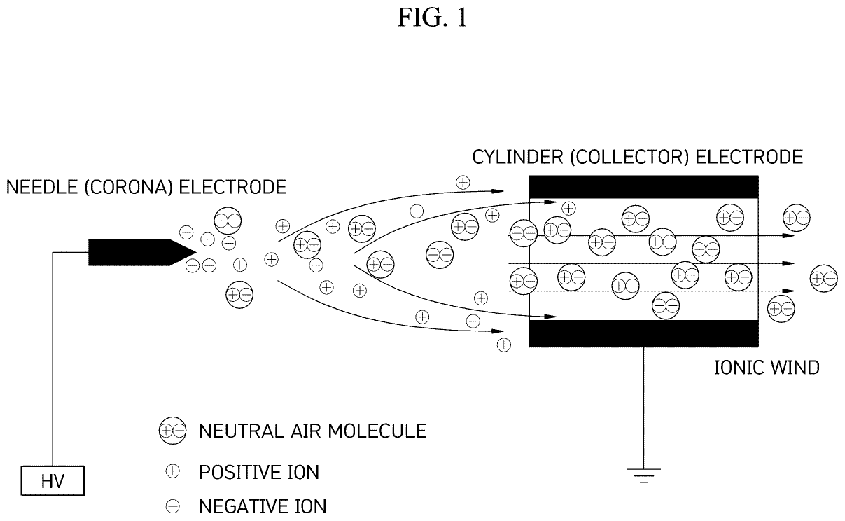

### MODE FOR INVENTION

Hereinafter, embodiments of the present disclosure are described more specifically with reference to the accompanying drawings.

An apparatus for generating and accelerating an ionic wind according to the present embodiment can remove pollutants in the air by widely diffusing an ionic wind generated by plasma discharge into the air by accelerating the ionic wind, and operates not only in the event of a fire but also under normal conditions.

In various types of “guide lights and illumination devices”, the extent to which the emitted light penetrates fine dust, exhaust fumes, smoke, and suspended particles even under normal conditions is a critical factor, depending on the installation environment.

In particular, the visibility of a signage device for an emergency escape is greatly improved when the present disclosure is applied to the signage device for an emergency escape due to the ability to settle the ions of noxious gases and granular materials generated from combustion, such as smoke and toxic gases, ultra fine dust, soot, exhaust soot, and smoke particles generated upon fire, to the floor by neutralizing the ions. The improved visibility means that, even in urgent situations during a fire, the signage remains clearly discernible to evacuees. Even the mere ability of a person in distress to visually locate the signage device can drastically reduce the fatality rate.

Furthermore, under normal conditions, indoor ultra fine dust and external inflow yellow dust are settled to the floor by neutralizing the indoor ultra fine dust and the external inflow yellow dust and the air is purified, a clear line of sight is maintained, and emergency guide lights remain easily visible, thereby providing both improved visibility and a cleaner air environment.

The signage device may be disposed at various types of buildings, underground parking lots, and special facilities, emergency escapes, such as various types of tunnels, large vessels, subways, factories, large warehouse stores, and multi-use facilities, and points including emergency exit doors, door frames, stairs, corridors, ceilings, side walls, and floors, and may be fabricated and applied in any shape.

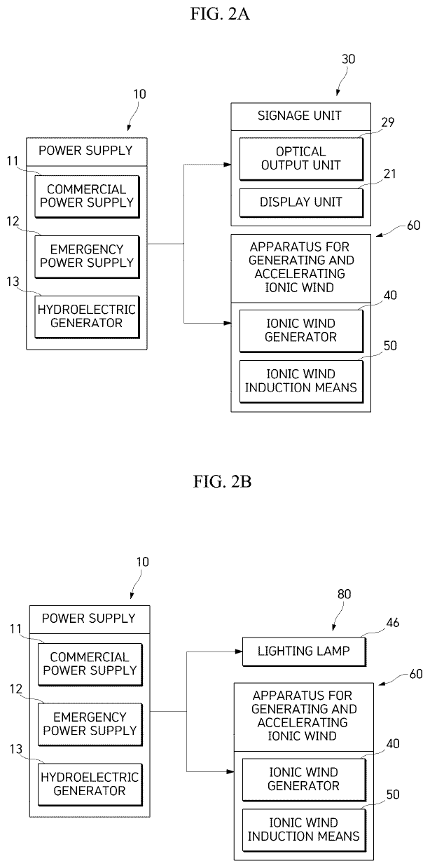

FIG. 2A is a block diagram illustrating an operating method of a high-visibility signage device 20 including an apparatus for generating and accelerating an ionic wind according to an embodiment of the present disclosure.

As illustrated, the high-visibility signage device 20 according to the present embodiment includes a power supply 10, a signage unit 30, and an apparatus 60 for generating and accelerating an ionic wind.

The power supply 10 supplies power for driving the high-visibility signage device 20, and includes a commercial power supply 11, an emergency power supply 12, and a hydroelectric generator 13.

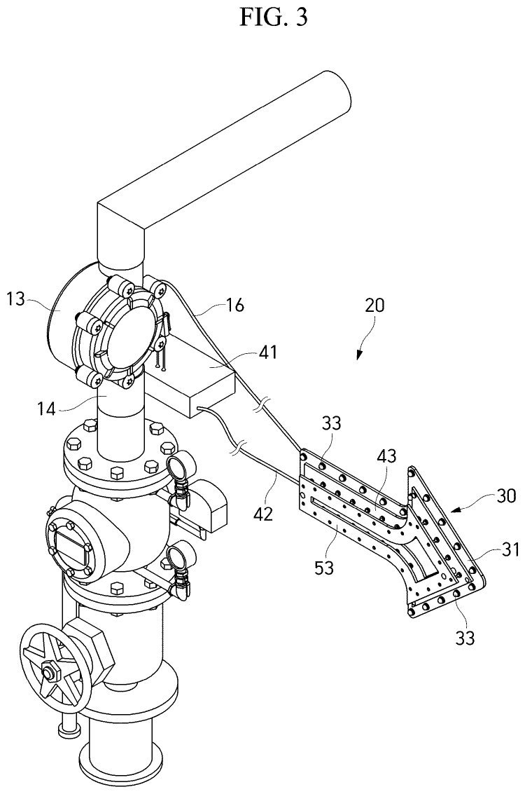

The commercial power supply 11 supplies electrical power under normal conditions, and the emergency power supply 12 operates when a power outage occurs due to a fire or other causes. Furthermore, the hydroelectric generator 13 is a facility that is mounted on a firefighting water pipe (14 in FIG. 3) through which firefighting water passes and that produces power by receiving kinetic energy of firefighting water. When a sprinkler operates upon fire, the hydroelectric generator 13 also automatically operates and produces power. Contents related to the hydroelectric generator installed in the fire fighting water pipe were disclosed in Korean Patent No. 10-2485464 that was applied and registered by the inventors of the present disclosure.

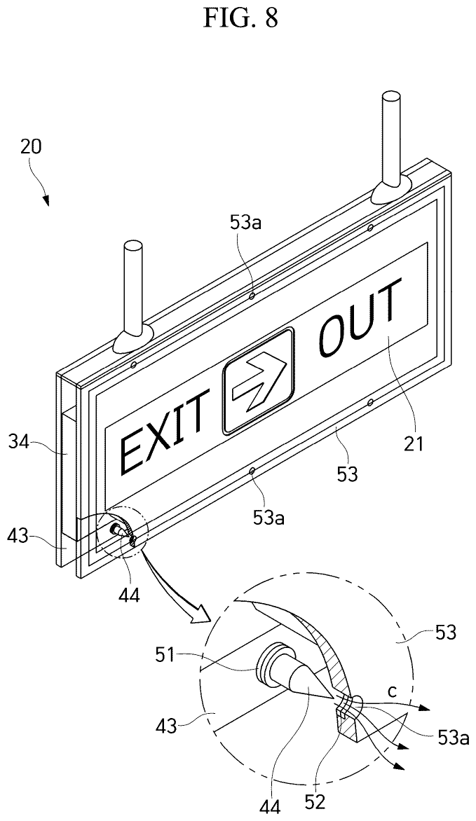

The signage unit 30 includes an optical output unit 29 and a display unit 21. The optical output unit 29 is a surface light unit 34 including a fluorescent lamp or a special lamp or an LED lamp 33, and a description related thereto is described later. Furthermore, the display unit 21 is a part that shows signage contents. The display unit 21 is a target to be viewed, which is viewed by eyes of people, and may be implemented with characters or arrow figures as illustrated in FIGS. 8, 9, and 11.

The apparatus 60 for generating and accelerating an ionic wind functions to generate an ionic wind and diffuse the ionic wind to the front of the display unit 21. The reason why the ionic wind is diffused to the front of the display unit 21 is for ion particles that constitute the ionic wind to settle pollutants in front of the display unit by neutralizing the pollutant. Furthermore, the reason for diffusing the ionic wind to the front of the display unit 21 is to improve the visibility of the display unit.

The apparatus 60 for generating and accelerating an ionic wind includes an ionic wind generator 40 and ionic wind induction means 50. The ionic wind generator 40 generates an ionic wind. The ionic wind induction means 50 leads the generated ionic wind to the front of the display unit 21 by accelerating and diffusing the ionic wind.

FIG. 2B is a block diagram illustrating an operating method of a high-visibility lighting device 80 including the apparatus for generating and accelerating an ionic wind according to an embodiment of the present disclosure.

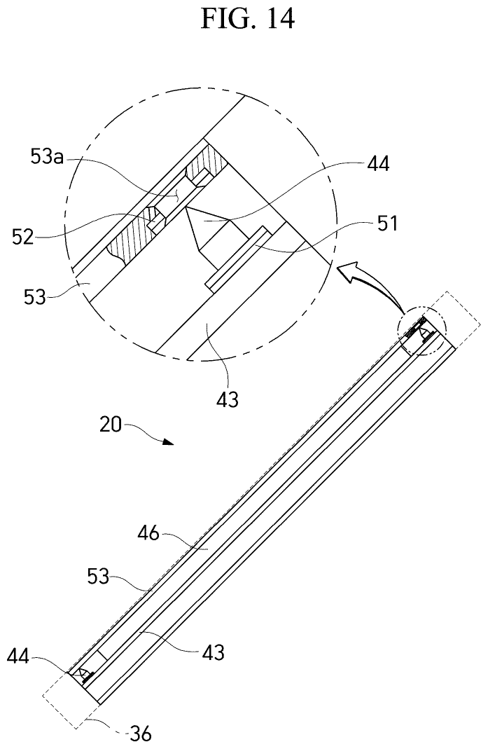

The high-visibility lighting device 80 includes a lighting lamp 46 instead of the signage unit 30 of FIG. 2A. The lighting lamp (46 in FIGS. 13 and 14) is a lamp that illuminates an indoor space, and is packaged along with the apparatus 60 for generating and accelerating an ionic wind. An ionic wind is sent to the front of the lighting lamp 46 and improves the visibility of the lighting lamp. The lighting lamp 46 may also be said to be a target to be viewed, which is viewed by the eyes of people, because the lighting lamp functions to provide notification of an escape route in the event of fire.

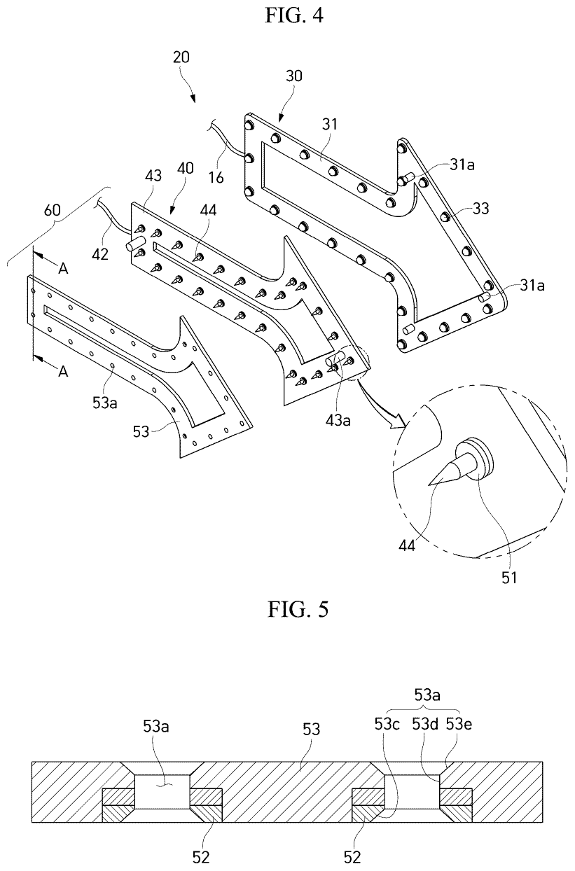

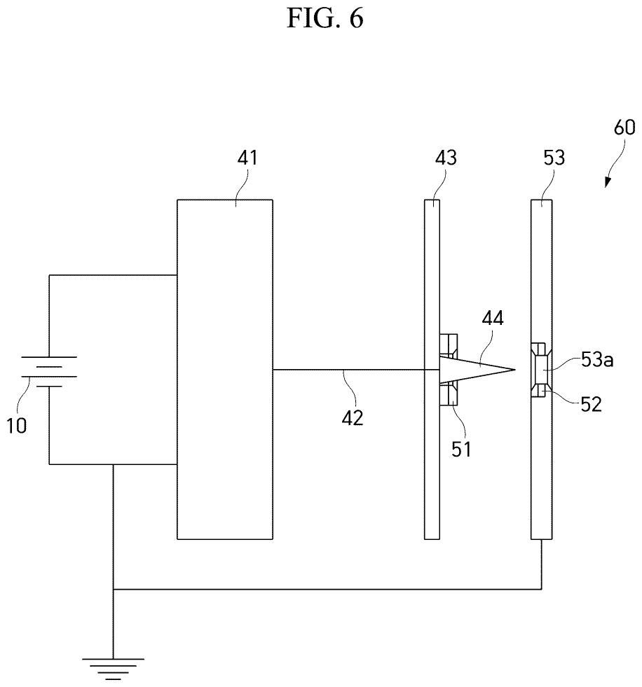

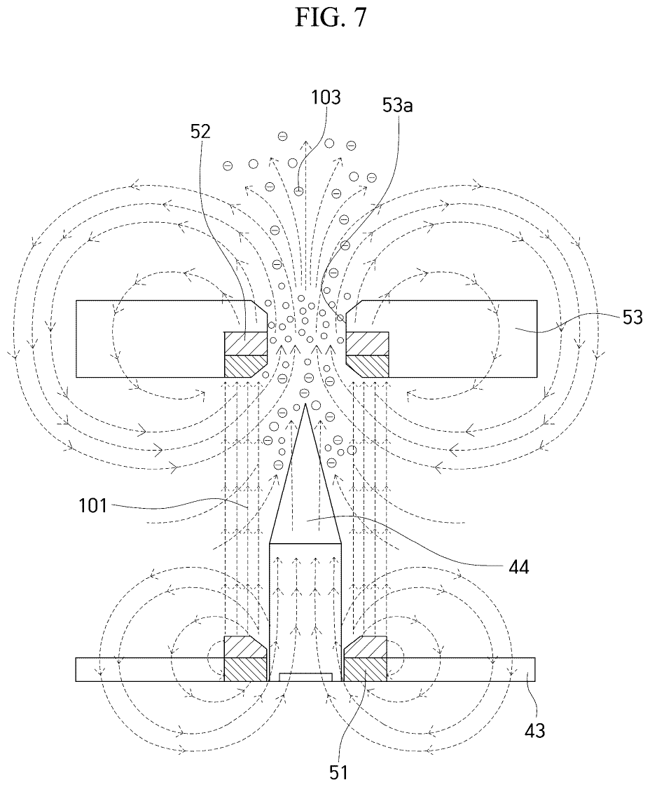

FIG. 3 is a perspective view of the high-visibility signage device 20 using the apparatus for generating and accelerating an ionic wind according to an embodiment of the present disclosure. FIG. 4 is an exploded perspective view of the display device of FIG. 3. FIG. 5 is a cross-sectional view taken along line A-A in FIG. 4. FIG. 6 is a diagram for describing an operating principle of the apparatus for generating and accelerating an ionic wind according to an embodiment of the present disclosure. FIG. 7 is a diagram for describing an ionic wind acceleration principle in the apparatus for generating and accelerating an ionic wind, which is illustrated in FIG. 6.

The high-visibility signage device 20 illustrated in FIG. 3 includes the hydroelectric generator 13, a high voltage generator 41, the signage unit 30, and the apparatus 60 for generating and accelerating an ionic wind.

The hydroelectric generator 13 is mounted on the fire fighting water pipe 14, and is power supply that produces power by receiving kinetic energy of fire fighting water that passes through the fire fighting water pipe 14. Some of the power of the hydroelectric generator 13 is transmitted to the signage unit 30 through the power line 16, and the remainder of the hydroelectric generator 13 is supplied to the high voltage generator 41.

The signage unit 30 is a target to be viewed, including a board plate 31 and multiple LED lamps 33, that is, optical output units. In the present embodiment, the LED lamp 33 has been taken as an example, but other types of known lamps may be applied in addition to the LED lamp 33.

The board plate 31 is a flat panel member having an arrow shape, and is connected to the hydroelectric generator 13 through a power line 16. A circuit for driving the LED lamps 33 is mounted on the board plate 31.

Furthermore, the LED lamps 33 are arranged along a shape of the board plate 31. A virtual straight line that connects the LED lamps 33 generally has an arrow shape. The LED lamps 33 provide guidance to a direction in the state in which the LED lamps have been turned on. For example, the LED lamps point out an escape route so that people can escape to a direction indicated by the LED lamps 33 in the event of fire.

The signage unit 30 has an arrow shape, but the shape and size thereof may be different. Furthermore, a location where the high-visibility signage device 20 is installed may be variously selected.

Reference numeral 31a is a spacer. The spacer 31a functions to maintain an interval between the board plate 31 and a discharge electrode plate 43.

The high voltage generator 41 outputs high voltage power for plasma discharge by using power applied from the hydroelectric generator 13. The high voltage power that is output from the high voltage generator 41 is transmitted to the discharge electrode plate 43 through a power line 42.

The discharge electrode plate 43 is a flat-type material having an arrow shape, which provides a support force, and supports multiple electrode members 44. The size of the discharge electrode plate 43 is smaller than the size of the board plate 31 so that the LED lamps 33 protrude to the front of the discharge electrode plate 43. The reason why the discharge electrode plate 43 has the arrow shape is that the signage unit 30 has an arrow shape and the LED lamps 33, that is, optical output units, are arranged in the arrow shape. In other words, the discharge electrode plate 43 has the arrow shape so that an electrode member 44 is brought to each of the LED lamps 33 as close as possible. A circuit (not illustrated) that connects the power line 42 and each electrode member 44 is mounted within the discharge electrode plate 43.

Multiple spacers 43a are also fixed to the discharge electrode plate 43. The spacer 43a functions to maintain an interval between the discharge electrode plate 43 and an acceleration plate 53.

The electrode member 44 is mounted on a front surface of the discharge electrode plate 43 and internally connected to the high voltage generator, and generates an ionic wind by ionizing surrounding air through plasma discharge. In the present embodiment, the electrode member 44 is an acicular electrode having a shape in which a front part of the electrode member is pointed. The electrode member 44 is disposed so that the central axis line of the electrode member passes through the central part of a Venturi hole 53a. The electrode member 44 may be fabricated and applied in a rod-type bar type in addition to the acicular type. Furthermore, the electrode member 44 may also be fabricated in the form of carbon brush in order to increase the amount of air ionization.

The discharge electrode plate 43 and the multiple electrode members 44 constitute the ionic wind generator 40 that generates an ionic wind. The ionic wind generated by the ionic wind generator 40 is accelerated and diffused by the ionic wind induction means 50 and diffused to the front of the high-visibility signage device 20, thus improving the visibility of the LED lamps 33.

The ionic wind induction means 50 functions to accelerate and diffuse an ionic wind generated by the ionic wind generator. To this end, the ionic wind induction means 50 includes a magnet and the acceleration plate 53.

The magnet includes a first magnet 51 and a second magnet 52. The first and second magnets 51 and 52 are each a neodymium magnet having a ring shape, and output the same magnetic force. However, the first magnet 51 and the second magnet 52 may have different magnetic forces. In the present embodiment, the first and second magnets 51 and 52 each have been implemented to have a ring shape, but the shape and size of each of the first and second magnets 51 and 52 may be variously changed.

The first magnet 51 is fixed to the discharge electrode plate 43 in the state in which the first magnet surrounds the electrode members 44 as illustrated in FIG. 6 or 7. Furthermore, the second magnet 52 is mounted on the acceleration plate and has the same inner diameter as the Venturi hole 53a. A part of the Venturi hole 53a is the second magnet.

The first magnet 51 and the second magnet 52 are disposed with the electrode member 44 interposed therebetween, and correspond to each other in a one-to-one way, and form a magnetic force line tunnel 101. The magnetic force line tunnel 101 accelerates ions around the electrode members 44 so that the ions pass through the Venturi hole 53a at a high speed. The reason why the ions are accelerated is to send the ions far away.

The acceleration plate 53 is a sheet-type member that is spaced apart from the discharge electrode plate 43 with the electrode member 44 interposed therebetween, and includes the multiple Venturi holes 53a. The Venturi hole 53a corresponds to each electrode member 44, and is a hole through which the central axis line of the electrode member passes. Furthermore, as described above, the second magnet 52 is mounted on the acceleration plate 53. The second magnet 52 forms a part of the Venturi hole 53a.

An inflow unit 53c, an acceleration unit 53d, and an outflow unit 53e are formed on an inner circumferential surface of the Venturi hole 53a. The inflow unit 53c is a part that receives an ionic wind. The acceleration unit 53d is a part that accelerates an ionic wind that passes through the inflow unit. Furthermore, the outflow unit 53e is a part that diffuses an ionic wind passing through the acceleration unit. A part of each of the inflow unit 53c and the acceleration unit 53d is an inner circumferential surface of the second magnet 52.

The reason why an ionic wind passing through the Venturi hole 53a is accelerated is that the inner diameter of the acceleration unit 53d at the center of the Venturi hole 53a is smaller than the inner diameter of the inflow unit 53c or the outflow unit 53e. The Venturi hole 53a has been applied from the Venturi principle. Furthermore, the outflow unit 53e has a shape in which the outflow unit is widened in a direction that is distant from the acceleration unit. Accordingly, an ionic wind passing through the acceleration unit 53d is diffused through the outflow unit 53e.

As a result, an ionic wind 103 that is primarily accelerated by the magnetic force line tunnel 101 can reach a longer place while being diffused into the air because the ionic wind 103 is additionally accelerated and diffused through the Venturi hole 53a. As the ionic wind reaches a longer place, a visibility improvement effect is increased because the range of purification of suspended matters is widened.

In FIG. 3, the hydroelectric generator 13 has been illustrated as a power supply for driving the high-visibility display device 20. However, the signage unit 30 and the apparatus 60 for generating and accelerating an ionic wind may be connected to the commercial power supply or the emergency power supply in parallel. Under normal operating conditions, the signage unit 30 and the apparatus 60 for generating and accelerating an ionic wind may be turned on by the commercial power supply. In the event of a power outage due to a fire, the device switches to the emergency power supply, thereby enabling a normal operation.

FIG. 8 is a partially cut perspective view of the high-visibility signage device 20 including the apparatus for generating and accelerating an ionic wind according to an embodiment of the present disclosure.

The same reference numeral as the reference numeral indicates the same member having the same functions. Furthermore, in the drawings, the power supply 10 is omitted.

The high-visibility signage device 20 illustrated in FIG. 8 includes a signage unit, an ionic wind generator, and ionic wind induction means.

The signage unit includes the surface light unit 34 and the display unit 21 as an optical output unit. The surface light unit 34 is a module including a fluorescent or special lamp (not illustrated) and a circuit board that drives the fluorescent or special lamp, and is connected to the power supply 10. The signage unit is turned on by being supplied with power of the power supply. The surface light unit 34 has an approximately square plate shape, and is disposed between the discharge electrode plate 43 and the acceleration plate 53.

The display unit 21, which serves as a visually recognizable target for individuals, is formed in the acceleration plate 53. That is, the display unit 21 is formed in a part of the acceleration plate 53. The display unit 21 is installed in front of the surface light unit 34, and is visually recognizable by taking the optical output unit as a backlight. Signage contents of the display unit 21 are various. In FIG. 8, characters and an arrow have been applied as the display unit 21, but a variety of figures, patterns, and pictures may be applied in addition to the characters or the arrow.

Furthermore, the discharge electrode plate 43 illustrated in FIG. 8 has a square plate shape, and includes three electrode members 44 at each of the top and bottom of the discharge electrode plate. Furthermore, the acceleration plate 53 also has a square plate shape, and covers the surface light unit 34. The acceleration plate 53 has the same width as the discharge electrode plate 43, and is disposed to be spaced apart from the discharge electrode plate 43 in parallel with the surface light unit 34 interposed therebetween.

Furthermore, three Venturi holes 53a are formed at each of the top and bottom of the acceleration plate 53. The Venturi hole 53a is a hole that transmits an ionic wind generated from the electrode member 44 in the direction of an arrow “c”. Furthermore, as described above, the ionic wind generated from the electrode member 44 is primarily accelerated by the first magnet 51 and the second magnet 52 and secondarily accelerated and diffused while passing through the Venturi hole 53a.

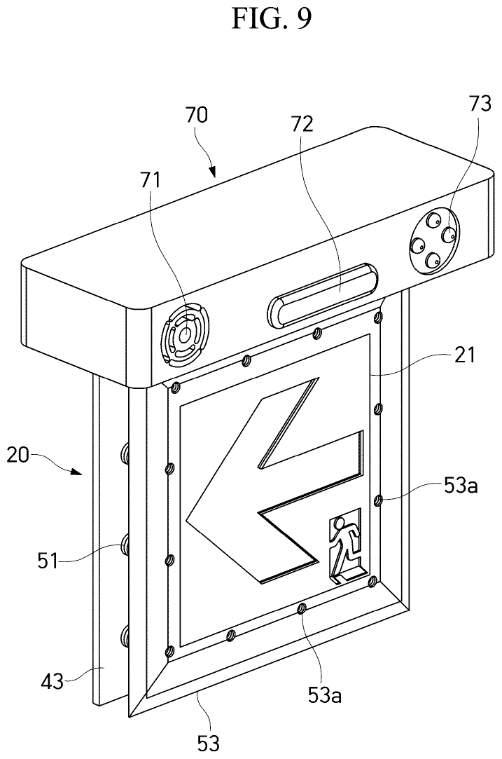

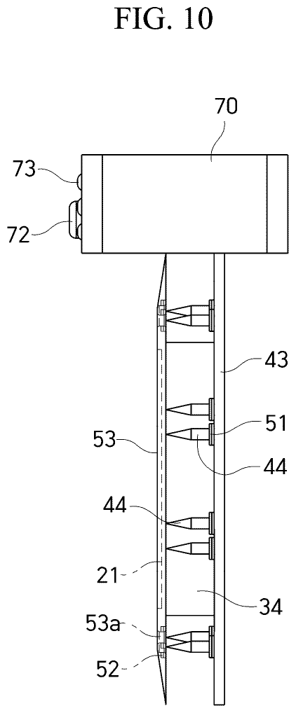

FIG. 9 is a perspective view illustrating another example of the high-visibility signage device including the apparatus for generating and accelerating an ionic wind according to an embodiment of the present disclosure. FIG. 10 is a side view of the high-visibility signage device illustrated in FIG. 9.

Referring to FIG. 9, it may be seen that an auxiliary warning module 70 is further installed over the discharge electrode plate 43 and the acceleration plate 53. The auxiliary warning module 70 operates when an emergency situation, such as a fire, occurs, and includes a speaker 71, a flasher 72, and an LED lamp 73. The auxiliary warning module 70 is an example of a blinking voice guide light for the visually and hearing impaired.

The speaker 71 is an alert indicating the occurrence of an emergency situation and outputs other necessary information. Furthermore, the flasher 72 operates in conjunction with the speaker and blinks when the speaker operates. Furthermore, the LED lamp 73 is a light that is always turned on. By incorporating such an auxiliary warning module 70, quicker evacuation can be facilitated.

The surface light unit 34 is installed between the discharge electrode plate 43 and the acceleration plate 53 in FIG. 9 as described above with reference to FIG. 8. Furthermore, the electrode members 44 and the first magnets 51 are mounted at the four sides of the discharge electrode plate 43. The Venturi holes 53a and the second magnets are provided in the acceleration plate 53.

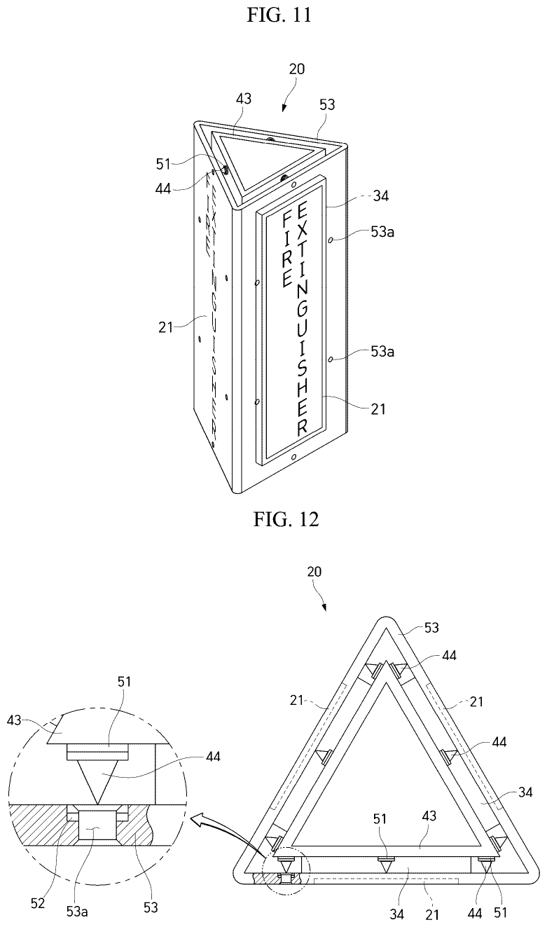

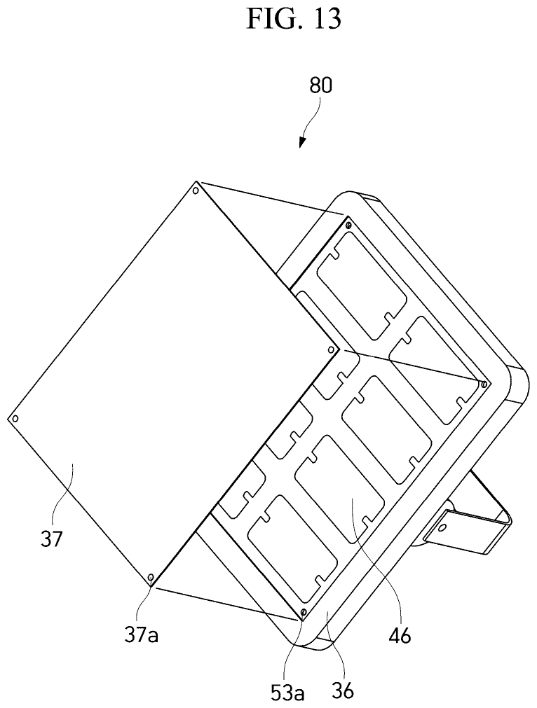

FIG. 11 is a diagram illustrating still another example of the high-visibility signage device 20 including the apparatus for generating and accelerating an ionic wind according to an embodiment of the present disclosure. FIG. 12 is a plan view of the high-visibility signage device 20 illustrated in FIG. 11. The high-visibility signage device 20 illustrated in FIG. 11 is not fixed in a ceiling, but is a type in which the high-visibility signage device is fixed to the sidewall of a tunnel so that the high-visibility signage device protrudes or high-visibility signage device stands upright on a floor.

The high-visibility signage device 20 illustrated in FIGS. 11 and 12 includes a triangular prism discharge electrode plate 43, a triangular prism acceleration plate 53, a display unit 21, a surface light unit 34, multiple electrode members 44, and first and second magnets 51 and 52.

The discharge electrode plate 43 has a triangular prism shape that perpendicularly extends, and is connected to the high voltage generator 41 and has the multiple electrode members 44 on a lateral surface thereof. The electrode member 44 generates an ionic wind through plasma discharge by receiving power from the high voltage generator 41. It is to be understood that a circuit that connects the high voltage generator 41 and the electrode members 44 may be formed within the discharge electrode plate 43.

The acceleration plate 53 also has a triangular prism shape and perpendicularly extends. The acceleration plate 53 accommodates the discharge electrode plate 43 therein. Furthermore, the display unit 21 and the multiple Venturi holes 53a are formed in each surface of the acceleration plate 53. The display unit 21 serves as a visually recognizable target for individuals.

Furthermore, the surface light unit 34 is installed between the acceleration plate 53 and the discharge electrode plate 43. The surface light unit 34 is turned on by receiving power of the power supply 10, and functions as the backlight of the display unit 21.

Ionic winds generated from the electrode members 44 pass through the first and second magnets 51 and 52 and the Venturi holes 53a, and are accelerated, diffused, and spread to the front of the display unit 21, thus improving the visibility of the display unit 21.

FIG. 13 is an exploded perspective view illustrating a high-visibility lighting device 80 including the apparatus for generating and accelerating an ionic wind according to an embodiment of the present disclosure. FIG. 14 is a diagram for describing internal components of the high-visibility lighting device of FIG. 13.

The high-visibility lighting device 80 includes a case 36 having a square frame shape, a discharge electrode plate 43, an acceleration plate 53, a transparent cover 37, a lighting lamp 46, an ionic wind generator, and ionic wind induction means.

The discharge electrode plate 43 and the acceleration plate 53 are spaced apart from each other in parallel with the lighting lamp 46 interposed therebetween, and are accommodated in the case 36.

Furthermore, the transparent cover 37 is a transparent plate member that transmits light radiated from the lighting lamp 46. The transparent cover 37 may be transparent plastic or glass. Through holes 37a are formed at four corners of the transparent cover 37. The through hole 37a is a hole through which an ionic wind passes.

The lighting lamp 46 is connected to the power supply 10 and radiates light by receiving power of the power supply. The light output by the lighting lamp 46 is radiated through the transparent cover 37. The lighting lamp may be an LED lamp, a fluorescent or mercury lamp, or a special lamp.

The ionic wind generator 40 includes a high voltage generator 41, the discharge electrode plate 43 that provides a support force, and electrode members 44 installed at the four corners of the discharge electrode plate. The electrode member 44 is connected to the high voltage generator, and generates an ionic wind by ionizing surrounding air through plasma discharge. Furthermore, Venturi holes 53a are formed at the four corners of the acceleration plate 53. The Venturi hole 53a is a hole that transmits an ionic wind.

Ionic winds generated from the electrode members 44 are accelerated through the magnetic force line tunnel 101 formed by the first and second magnets 51 and 52, and are then diffused through the Venturi holes 53a. The ionic winds are diffused to the front part of the lighting device 80. The diffused ionic winds neutralize and settle floating foreign substances on the front surface of the lighting device 80, thereby enhancing the visibility of the lighting device. In other words, the lighting becomes more distinctly and clearly visible.

The detailed embodiments of the present disclosure have been described above. It is evident that the present disclosure is not limited to the detailed embodiments and may be modified or improved by a person having ordinary knowledge in the art within the technical spirit of the present disclosure.

While various embodiments have been described above, it will be understood to those skilled in the art that the embodiments described are by way of example only. Accordingly, the disclosure described herein should not be limited based on the described embodiments.

1. An apparatus for generating and accelerating an ionic wind, the apparatus comprising:
a power supply;
a high voltage generator configured to output high voltage power for plasma discharge by receiving power of the power supply;
an ionic wind generator comprising a discharge electrode plate configured to provide a support force and multiple electrode members mounted on the discharge electrode plate, connected to the high voltage generator, and configured to generate an ionic wind by ionizing surrounding air through plasma discharge; and
ionic wind induction means for accelerating and inducing the ionic wind generated by the ionic wind generator.

2. The apparatus of claim 1, wherein the ionic wind induction means comprises a magnet configured to apply a magnetic force to the ionic wind generated by the ionic wind generator so that the ionic wind is accelerated by an action of the magnetic force.

3. The apparatus of claim 2, wherein the ionic wind induction means further comprises an acceleration plate configured to provide a Venturi hole that transmits the ionic wind accelerated by the magnet and that additionally accelerates the ionic wind.

4. The apparatus of claim 3, wherein:
the electrode member is an acicular electrode having a shape in which a front part thereof is pointed,
the acceleration plate is disposed to be spaced apart from the discharge electrode plate with the electrode member interposed therebetween, and
the Venturi hole is a through hole through which a central axis line of the electrode member passes, and comprises an inflow unit configured to receive the ionic wind, an acceleration unit configured to accelerate the ionic wind that passes through the inflow unit, and an outflow unit configured to diffuse the ionic wind passing through the acceleration unit.

5. The apparatus of claim 4, wherein the magnet comprises:
a first magnet having a ring shape and fixed to the discharge electrode plate in a state in which the first magnet surrounds the electrode member, and
a second magnet having a ring shape, mounted on the acceleration plate, and configured to form a magnetic force line tunnel that provides guidance to a flow of the ionic wind along with the first magnet.

6. The apparatus of claim 1, wherein the power supply comprises a commercial power supply, an emergency power supply that operates when the commercial power supply is blocked, or a hydroelectric generator mounted on a pipe through which fire fighting water passes and configured to produce power by receiving kinetic energy of the fire fighting water.

7. A high-visibility signage device comprising:
a power supply;
a signage unit comprising an optical output unit connected to the power supply and a display unit installed in front of the optical output unit, configured to indicate signage contents, and viewed by taking the optical output unit as a backlight;
an ionic wind generator comprising a high voltage generator configured to output high voltage power for plasma discharge, a discharge electrode plate configured to provide a support force, and multiple electrode members mounted on the discharge electrode plate, connected to the high voltage generator, and configured to generate an ionic wind by ionizing surrounding air through plasma discharge; and
ionic wind induction means for improving a visibility of the display unit by inducing the ionic wind generated by the ionic wind generator so that the ionic wind is spread to a front of the display unit.

8. The high-visibility signage device of claim 7, wherein the ionic wind induction means comprises a magnet configured to accelerate the ionic wind by an action of a magnetic force by applying the magnetic force to the ionic wind generated by the ionic wind generator.

9. The high-visibility signage device of claim 8, wherein the ionic wind induction means further comprises an acceleration plate configured to provide a Venturi hole that transmits the ionic wind accelerated by the magnet and that additionally accelerates the ionic wind.

10. The high-visibility signage device of claim 9, wherein the magnet comprises:
a first magnet having a ring shape and fixed to the discharge electrode plate in a state in which the first magnet surrounds the electrode member, and
a second magnet having a ring shape, mounted on the acceleration plate, and configured to form a magnetic force line tunnel that provides guidance to a flow of the ionic wind along with the first magnet.

11. A high-visibility lighting device comprising:
a power supply;
a lighting lamp connected to the power supply;
an ionic wind generator comprising a high voltage generator configured to output a high voltage for plasma discharge, a discharge electrode plate configured to provide a support force, and multiple electrode members mounted on the discharge electrode plate, connected to the high voltage generator, and configured to generate an ionic wind by ionizing surrounding air through plasma discharge; and
ionic wind induction means for improving a visibility of the lighting lamp by inducing the ionic wind generated by the ionic wind generator so that the ionic wind is spread to a front of the lighting lamp.

12. The high-visibility lighting device of claim 11, wherein the ionic wind induction means comprises a magnet configured to accelerate the ionic wind by an action of a magnetic force by applying the magnetic force to the ionic wind generated by the ionic wind generator.

13. The high-visibility lighting device of claim 12, wherein the ionic wind induction means further comprises an acceleration plate configured to provide a Venturi hole that transmits the ionic wind accelerated by the magnet and that additionally accelerates the ionic wind.

14. The high-visibility lighting device of claim 13, wherein the magnet comprises:
a first magnet having a ring shape and fixed to the discharge electrode plate in a state in which the first magnet surrounds the electrode member, and
a second magnet having a ring shape, mounted on the acceleration plate, and configured to form a magnetic force line tunnel that provides guidance to a flow of the ionic wind along with the first magnet.

15. The high-visibility lighting device of claim 14, wherein the magnet comprises:
a first magnet having a ring shape and fixed to the discharge electrode plate in a state in which the first magnet surrounds the electrode member, and
a second magnet having a ring shape, mounted on the acceleration plate, and configured to form a magnetic force line tunnel that provides guidance to a flow of the ionic wind along with the first magnet.
